(19) United States
(12) Patent Application Publication
(10) Pub. No.: US 2019/0216263 A1
(43) Pub. Date: Jul. 18, 2019

(54) Frying Pan with Filtration System Built Into a Handle/Pour Spout.

(71) Applicant: Amare Kelly, Auburn, VA (US)

(72) Inventor: Amare Kelly, Auburn, VA (US)

(73) Assignee: ProKell LLC, Ashburn, VA (US)

(21) Appl. No.: 15/873,756

(22) Filed: Jan. 17, 2018

(51) Int. Cl. A47J 37/10; A47J 36/14; A47J 37/12

(52) U.S. Cl. CPC A47J 37/108; A47J 37/1223; A47J 36/14

(57) ABSTRACT

A frying pan, from two inches to ten inches high, which includes an opening on the side of pan which connects through a removable filter screen holder to a hollow handle/spout that allows cooking oil and other liquids to be removed from the frying pan. By tilting and pivoting of the frying pan, the oil and other liquids can be caused to flow through the filter screen to then be dispensed exteriorly of the frying pan. The auxiliary handle/spout tilts slightly up so oil or liquids do not inadvertently drip out the hollow handle/spout when not desired.

This patent claims the benefit of Provisional Patent 62/461,423, filed on 2017-02-21

### PRIOR ART US PATENTS

| Patent number | Kind Code | Issue Date | Patentee |
|---|---|---|---|
| 3,477,361 | A | 1969 Nov. 11 | Wright D. Bradshaw |
| 3,977,973 | A | 1974 Apr. 28 | Lyle V. Anderson |
| 4,626,352 | A | 1984 Feb. 28 | Simon C. Massey |
| 5,653,881 | A | 1997 Aug. 5 | William Brass |
| 5,967,024 | A | 1999 Oct. 19 | Robert A. Demars |
| 6,439,110 | B1 | 2002 Aug. 27 | Shau Chiu Lin |
| 8,096,955 | B1 | 2012 Jan. 17 | Theresa P. Vasquez |
| 9,192,265 | B1 | 2015 Nov. 24 | Jeffrey A. Johnson |
| 9,723,955 | B2 | 2017 Aug. 8 | Shondelle Booker |

### PRIOR ART US PATENT APPLICATIONS

| Application # | Kind Code | Publication Date | Applicant |
|---|---|---|---|
| 20050087076 | A1 | 2005 Apr. 28 | Marcus Grunewald |
| 20050211106 | A1 | 2005 Sep. 29 | Luther Dierks |
| 20050247211 | A1 | 2005 Nov. 10 | Alan Crawford |
| | | | Robert DeMars |
| 20050263011 | A1 | 2005 Dec. 1 | Eric Golding |
| 20070261568 | A1 | 2007 Nov. 15 | Milton Smothers |
| 20080017047 | A1 | 2008 Jan. 24 | Edmund Stanczak |
| 20090173239 | A1 | 2009 Jul. 9 | Hyun Sam Lee |
| 20090277338 | A1 | 2009 Nov. 12 | Douglas Palmer |
| 20110038999 | A1 | 2011 Feb. 17 | Jeffrey Payne Lara |
| 20140131361 | A1 | 2014 May 15 | Otto Schroeder |

### FIELD OF THE INVENTION

The present invention relates to a cooking appliance which is both a frying pan sauce pan combination which allows cooking oil to be easily removed and filter removed by pouring the liquid through a aperture in the frying pan/saucepan wall into a filtering system which lies within a spout/handle attached to the frying pan/saucepan aperture. The object of the frying pan is to filter cooking oil so it can be reused.

BACKGROUND

Conventional frying pans leave leftover oil in the bottom of the pan. Users find it convenient to throw away the used oil because recycling is inconvenient and messy. The invention claimed here addresses this problem by allowing the used oil to flow out of an aperture in the pan, through a removable handle which contains a filtering system, producing clean oil for reuse. The secondary handle doubles as a pour spout to facilitate pouring of oil back into a container. The handle/spout contains a small machine-washable screen to trap crumbs/breading and unwanted food particles.

The market contains a large number of products designed to funnel grease away from the pan, but those pans do not recycle cooking oil, and are designed more for taking off grease, which is the result of cooking meat, and moving it away from the still cooking meat. There are products for filtering oil in deep fat fryers, but they are not integral to the frying pan, but rather a stand-alone filtering system connected by piping to the deep fat fryer.

### Discussion Regarding Prior Art

There are several patents and patent applications relating to what in effect is grease-free cooking with frying pans. They include methods of separating the grease, methods of removing the grease from the pan with the use of spouts, and methods of filtering cooking oil outside of deep fat frying pans. Only the filtering methods for deep fat fryers address recycling of cooking oil, but the patents on the removal of grease should be considered.

One set of prior art patents and applications deal with having a grease collection area below the cooking surface. U.S. Pat. No. 6,439,110 (Shao chin Lin) has a cooking section that lifts and allows the grease to be poured off. U.S. Pat. No. 9,723,955 (Booker) has a cooking surface with holes, which lifts up, allowing the grease and oil to go into the bottom of the frying pan. 20050087076 (Grunewald) has a raised floor of the frying pan that allows grease to go underneath it. 20050211106 (Dierks) has ribs that allow oil an grease to dip below the object being cooked. 20050247211 (Crawford) has a drip tray below a cooker that can be removed and the oil and grease collected can be removed. 20140131361 (Schroeder) has an downward sloping shelf attached to the outside edge of the frying pan to direct oil and grease away from the cooking surface

A second set or prior art advances spouts or variations of spouts on the side of the frying pan. 20050263011 (Golding) has a spout that takes liquids from a space between the interior and exterior side walls. 20070261568 (Smothers) advances a triangular pan design that has the upper corners configure to allow oil and grease to be poured out of the pan. 20080017047 (Stanczak) has a separate holding device for the frying pan, which allows the frying pan to be tipped with oil and grease removed from the pan through a spout. 20090173239 (Hyun Sam Lee) has the top edge of the frying pan configure with one or more arched sections to facilitate the removal of oil and grease.

Another set of patents and patent applications offer strainer devices that allows the grease and oil to fall into a reservoir. U.S. Pat. No. 4,626,352 (Massey) and U.S. Pat. No.5,653,881 (Bruss) both offer straining vessels with compartments to hold the oil and grease.

U.S. Pat. No. 9,192,265 (Johnson) has a grease and oil collection container, where a frying pan, with a spout, can fit into a slot that puts the frying pan at an angle to dispose of unwanted oil and grease.

An application that uses the handle for a spout is shown in 20090277338 (Palmer), though it does not have a filtering system.

Two patents were uncovered that have cavities for collecting material and then a spout for pouring the undesired liquid out. U.S. Pat. No. 5,967,024 (DeMars) collects grease in a bottom compartment that is then removed with the use of a spout. U.S. Pat. No. 8,096,955 (Vasquez) is a specimen collection system, but it contains a holding system for liquids on the bottom that is removed with a spout. 20110038999 (Lara) has a bottom reservoir for collecting and storing liquids, and rather than a spout, has a semi-spout designed into the top edge of the frying pan.

U.S. Pat. No. 3,477,361 (Bradshaw) is a deep fat fryer system that has a separate filter system that is accessed through piping. U.S. Pat. No. 3,977,973 (Anderson is a deep fat fryer, with a filtering compartment that takes small quantities of oil, filters them and then sends them back to the fryer section.

None of the prior has a filtering system built into the handle or spout and its holder, attached to the frying pan, which is the key novel feature of the present invention.

### SUMMARY OF THE INVENTION

A frying pan, from two inches to ten inches high, which includes an opening on the side of the frying pan, a holder with a slot for the removable machine washable filtering screen that attaches to the side of the frying pan, with an opening that matches the opening in the frying pan, a hollow handle/spout of three to nine inches with the hollow area circumference the same size as the opening in the frying pan which is attached to the holder the of the filtering screen, and has a five to fifteen degree upward tilt. The holder is larger than the size of the opening in the frying pan, and the filtering screen can be the same size as the opening in the frying pan or larger than the opening of the frying pan. The holder is attached to the frying pan and the handle/spout is attached to the holder by welding or other industry standard attachment method, or through a one piece manufacturing process. By tilting and pivoting of the frying pan, the oil and other liquids can be caused to flow through the filtering system to then be dispensed exteriorly. The holder attached to the frying pan that holds both the slot for the removable filter and provides a base to permanently attach handle spout containing the filtration system in the preferred embodiment.

The frying pan itself has an internal chamber which has a substantially flat base, with the flat base having an interior surface and an exterior surface, the interior surface surrounded by a circumferential upstanding sidewall, the upstanding sidewall having an upper free edge, said exterior surface adapted to be placed against a source of heat, said interior surface adapted to have a foodstuff located thereon to be cooked by the source of heat;

Main components of the Frying Pan with Filtration System Built Into a Handle/Spout are:
1. The body of the frying pan
2. One standard handle
3. One holder for the filtering screen attached to the frying pan that serves as the attachment location for the handle/spout.
4. One elongated handle/spout
5. Small filtering screen that rests in a slot in the holder permanently attached to the handle/spout.

Other embodiments of the frying pan are:

Besides varying heights for the pan, ranging from two to eight inches, the length of the handle/spout, ranging from three to nine inches, the size of the filtering screen and the size of the holder, other potential embodiments of the invention are:
1. the holder acts as a machine thread anchor, holding in the threaded end of the handle/spout. In the preferred embodiment the handle/spout does not have a threaded end;
2. the location of the holder of the filtering screen can be moved to varying points on the handle/spout, which may be at the end of the handle/spout;
3. The filtering screen may have a gasket type cover that is machine washable around the outside edge of the filtering screen;
4. The upward tilt of the handle spout may be more or less than the five to fifteen degree tilt of the preferred embodiment.
5. the handle/spout can be removable with a variety of frying pan industry standard methods other than having screw threads on one end of the auxiliary handle and a machine thread anchor in the holder of the removable filter.
6. The slot for the removable filtering screen can be manufactured into the handle/spout and remove the need for a separate holder

### Advantages of the Invention

1. Makes it possible to recycle cooking oil.
2. Provides a way to pour out and filter used frying oil without any ad on parts.
3. Minimizes spillage from dumping out cooking oil during disposal or saving.
4. Allows the frying pan to be used as a saucepan.
5. Provides a convenient way to remove excess water when used as a saucepan.

### DRAWING FIGURES

FIG. 1 is a ¾ top view of the Frying Pan with Filtration System Built-In to Handle/Pour Spout with the removable filter about to inserted into its holder which is attached to the frying pan

FIG. 2 is a side view of the Frying Pan with Filtration System Built-In to Handle/Pour Spout with removable filter inserted into its holder which is attached to the frying pan.

FIG. 3 is a side view front view of the removable filter installed into its holder which is attached to the frying pan with the view of the holder/spout not shown.

FIG. 4 is a top view of the Frying Pan with Filtration System Built-In to Handle/Pour Spout.

FIG. 5 shows the Frying Pan with Filtration System Built-In to Handle/Pour Spout in use, with the oil or other liquid being poured into a container.

FIG. 6 is a view of the handle/spout with screw threads so that it can screwed into the holder of the removable filter in an alternative embodiment.

FIG. 7 illustrates how the holder attached to the frying pan for the removable filter is thicker in order to have screw threads placed into the holder.

FIG. 8 illustrates how the holder with the slot for the removable filtering screen can be positioned at various points along the handle/spout, with the handle spout attached to either side of the holder.

### DRAWINGS REFERENCE NUMBERS

1. Two to eight inch frying pan/saucepan.

2. Removable screen filter with a small handle.

3. Permanently attached holder with a slot for the removable screen filter and that attaches to the handle/spout.

4. Standard pot/frying pan handle.

5. Hollow holder/spout.

6. End of holder/spout illustrating the exit point for oil or grease

7. Screw thread end for spout/handle for second embodiment when the handle/spout is removable

8. Configuration of holder when it acts as a screw anchor for the handle/spout.

9. An example of one of many receptacles that the excess oil can be poured into.

10. Hollow handle/spout with a one end configured in a screw type configuration.

11. The removable screen filter holder with a screw anchor machining (or molded in construction).

### DETAILED DESCRIPTION OF THE FIGURES

The drawings present the preferred embodiment of the invention. Variations in each of the components is possible and mentioned in some of the additional embodiments listed in the

### SUMMARY OF THE INVENTION SECTION

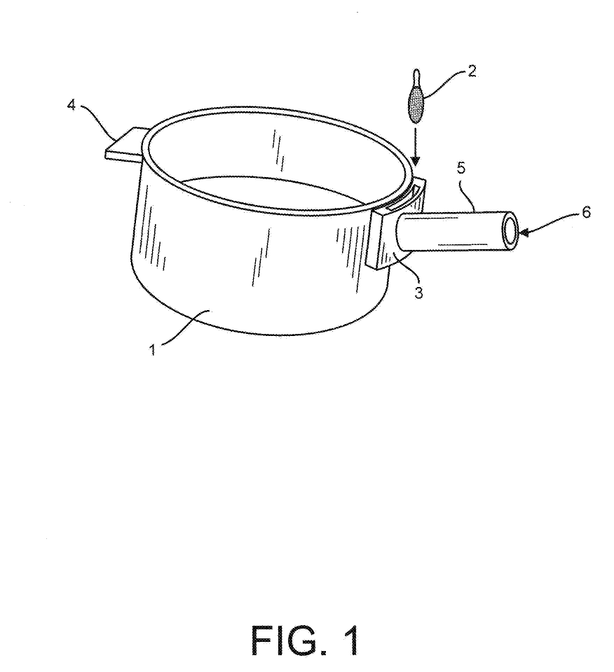

FIG. 1 shows the preferred embodiment with a frying pan 1, six to eight inches in height, a standard industry type handle 4 a holder that attaches to the frying pan 3 that contains a slot for the removable screen filter with handle 2, with the hollow handle/spout 5 permanently attached to the holder 3 and exiting the frying pan at a slight incline. The exit point of the spout 6 is at the end of the hollow handle/spout 5.

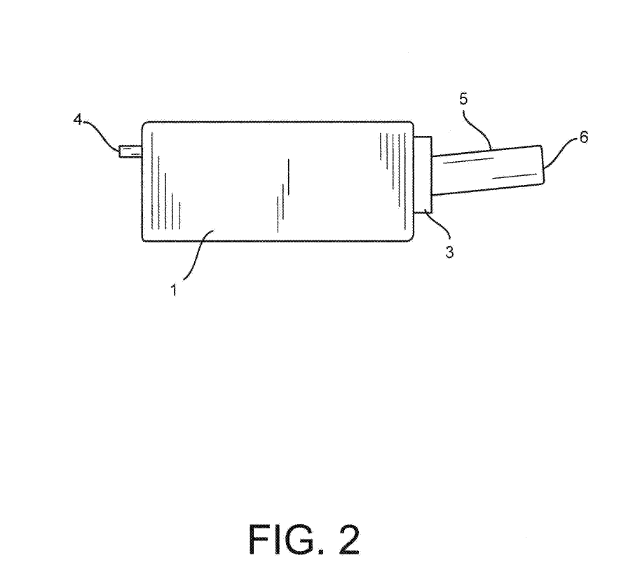

FIG. 2 shows the preferred embodiment of the frying pan from a side view with the removable filter (not shown in figure) inserted. The standard handle 4 may be any of a wide variety of handles, is permanently attached to the frying pan 1. The hollow handle/spout 5 is permanently attached to the removable filter screen holder 3, which in turn is permanently attached to the frying pan 1.

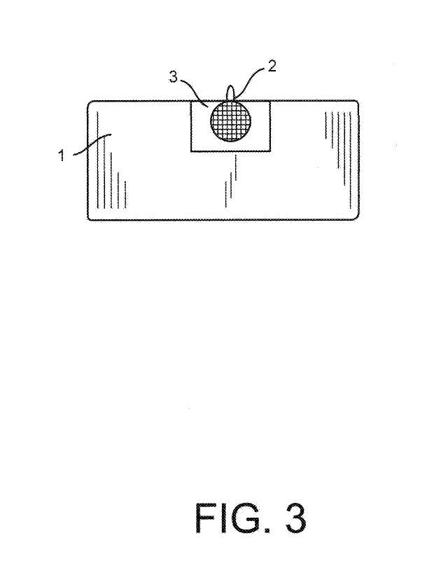

FIG. 3 shows the frying pan 1 from the side where the hollow handle/spout has been deleted. The drawing shows how the removable screen filter 2 sits in the holder 3.

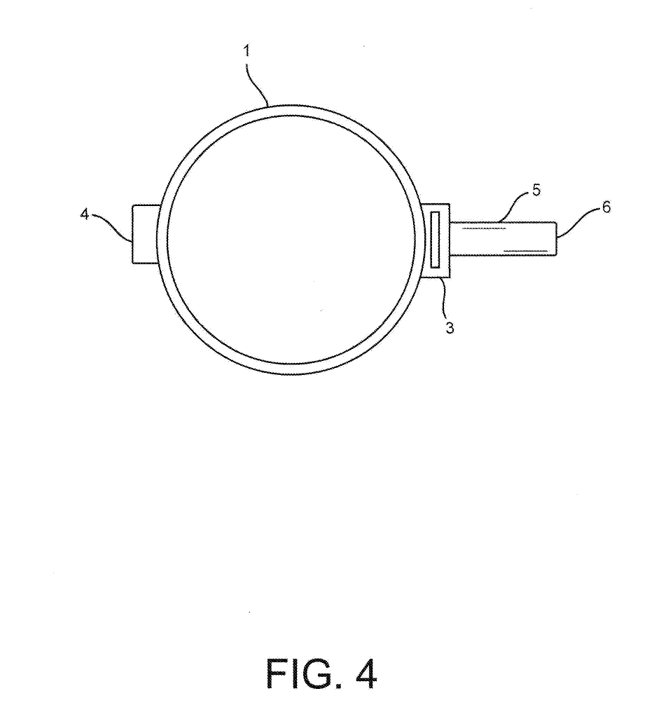

FIG. 4 shows the frying pan 1 from a top view with a standard handle 4 on one side, opposite the removable filter holder 3 and the hollow handle spout 5. The end of the handle, is the point that oil or liquids is poured off the frying pan 1.

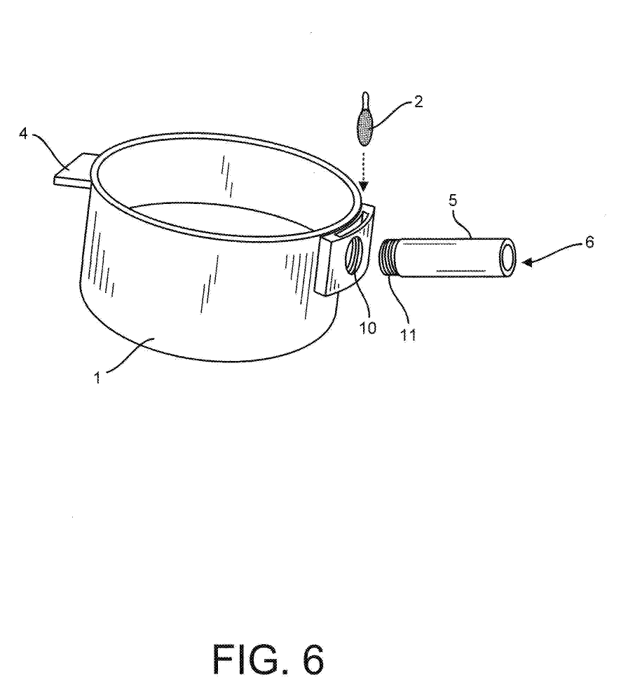

FIG. 5 demonstrates how the frying pan 1, is tilted in order to remove some or all of the cooking oil or liquid. The removable screen filter 2 is inserted into its holder 3, the standard handle 4 is lifted and oil or liquid flows out of the end 6 of the hollow handle/spout 5 into a container 9. The container 9 is not part of the invention and can be any number of different type commercially available containers.

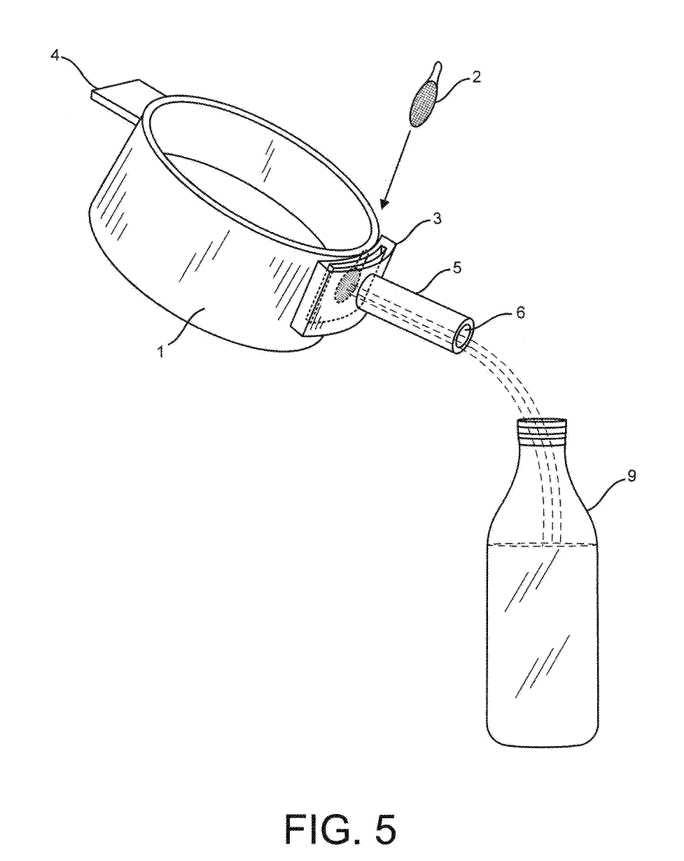

FIG. 6 illustrates what the hollow tube 10 looks like when one end has a screw type grooves so it can be removed with a turning action from its holder 11, which has a screw anchor in this alternative embodiment.

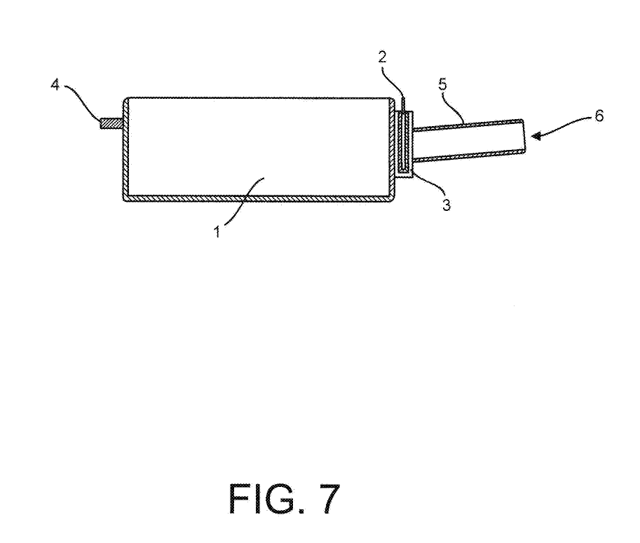

FIG. 7 shows the frying pan 1 from a side view, with its standard handle 4, the holder for the removable filter 3, with the removable filter 2 inserted, and the hollow handle/spout 5, and the dispensing end of the spout 6.

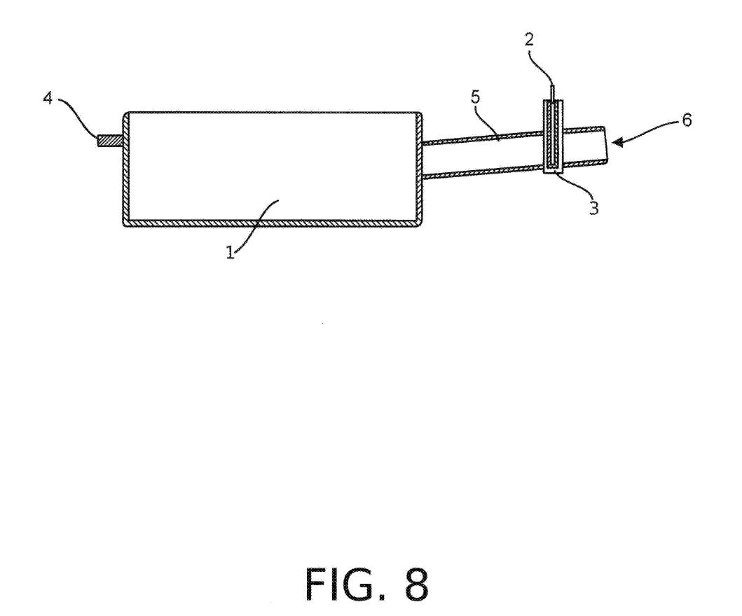

FIG. 8 show how the holder for the filtering system can be positioned at varying points along the handle/spout if desired with the holder 3 and the removable filter screen 2 be placed at any point along the handle spout, including at the end 6 of the handle/spout.

What is claimed is:

1. A frying pan from two to 10 inches high with a filtration system built into a hollow handle/pour spout comprising:
a. the frying pan having an internal chamber which has a substantially flat base, the flat base having an interior surface and an exterior surface, the interior surface surrounded by a circumferential upstanding sidewall, the upstanding sidewall having an upper free edge, the exterior surface adapted to be placed against a source of heat, the interior surface adapted to have a foodstuff located thereon to be cooked by the source of heat;
b. an opening on one side of the frying pan for releasing cooking oil and liquids;
c. a holder, with an opening similar in size to the opening in the frying pan, permanently attached to the frying pan, with the opening the holder aligned with the opening of the frying pan;
d. the holder having a slot that fits a removable screen filter
e. the holder permanently attached to a hollow handle/spout on the opposite side of the holder from the frying pan, the hollow handle/pour spout inclined five to fifteen degrees in the upward direction;
f. the hollow handle/spout having inlet and outlet openings similar in size to the of the opening in the frying pan;
g. a conventional handle on one side of the frying pan.

2. The frying pan of claim 1, where the hollow handle/spout has screw threads on one end, and where the holder attached to the frying pan has a screw insert manufactured in its body to hold the hollow handle/spout with a screw thread.

3. The frying pan of claim 1 with the removable screen filter holder being placed in to at various locations along the length of the handle/spout.

4. The frying pan of claim 1 with the removable screen filter holder being placed in the outlet section of the handle spout, where oil or liquid flow from the frying pan.

5. The frying pan of claim 1 with a gasket type material being placed on the outer edge of the removable screen filter.

6. The frying pan of claim 1 with the slot for the removable filtering manufactured into the handle/spout and remove the need for a separate holder.
